(19) United States
(12) Patent Application Publication
(10) Pub. No.: US 2010/0241737 A1
(43) Pub. Date: Sep. 23, 2010

(54) METHOD AND APPARATUS FOR ADDRESS VERIFICATION DURING MULTIPLE ADDRESSES REGISTRATION

(75) Inventors: Jun Hirano, Kanagawa (JP); Chun Keong Benjamin Lim, Singapore (SG); Chan Wah Ng, Singapore (SG); Tien Ming Benjamin Koh, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/438,484

(22) PCT Filed: Aug. 24, 2007
(86) PCT No.: PCT/JP2007/066950

§ 371 Date: Feb. 23, 2009

(30) Foreign Application Priority Data
Aug. 25, 2006 (JP) 2006-229163
Jul. 20, 2007 (JP) 2007-189163

(51) Int. Cl. G06F 15/177

(52) U.S. Cl. 709/220

(57) ABSTRACT

In this present invention, when the HA is performing Bulk Registration for a Multimode Node, the HA will tagged those CoAs specified within the single BU as unverified. A verification mechanism implemented at the HA will be triggered to test the addressability of the unverified CoA before using the said unverified CoA. The method of verification involves the HA to send an acknowledgment message to an unverified CoA of the Multimode Node to test the said unverified CoA for its addressability. When the Multimode Node receives the acknowledgment message from the HA, the Multimode Node replies the HA with another single BU. Upon the receipt of the second single BU from the Multimode Node, the HA can then verify that the said unverified CoA of the Multimode Node.

### TECHNICAL FIELD

This invention relates to the field of telecommunications in mobile communications networks. More particularly, it concerns how care-of addresses can be verified.

### BACKGROUND ART

Mobile IPv6 Non-patent Document 1, or MIPv6, allows a mobile node (MN) to bind its Care-of Address (CoA) to its Home Address (HoA) at its Home Agent (HA) to achieve reachability even if it is away from its home network. This method requires the MN to send a Binding Update (BU) message to its HA specifying the CoA that it wishes to be bounded to its HoA. Furthermore, in the not-so-distant future, laptops or other handheld electronic peripherals can be integrated with several network interfaces, thus allowing a MN to handle several CoAs bound to a single home address. With regards to MIPv6, it permits the use of the Alternate Care-of Address option to let a MN define multiple CoAs in a single BU. However, this option lacks the means for a MN to successfully achieve multiple bindings as current MIPv6only allows one CoA to be bound to a given HoA.

Presently, Mobile Nodes and Multiple Interfaces in IPv6 (Monami6) working group is defining a method to support the registration of multiple CoAs at a given Home Agent address . Internet draft “Multiple Care-of Addresses Registration” Non-patent Document 2 introduces an identification number called Binding Unique Identification (BID) number to distinguish between multiple bindings to a HoA. The BID is assigned to either the interfaces or CoAs bound to a single home address (HoA) of a mobile node. Therefore, the HoA is thus associated to a mobile node itself whereas the BID identifies each binding registered by a mobile node. The mobile node notifies the BID to its Home Agent by means of a BU. The Home Agent records the BID into its binding cache.

Additionally, in both Internet drafts, “Multiple Care-of Addresses Registration” Non-patent Document 2 and “Multiple CoA Performance Analysis” Non-patent Document 3, the authors propose an optimization method for registering multiple CoAs to a HA. This optimization method, henceforth known as bulk registration, allows the MN to bind multiple CoAs to a single HoA with a single BU message.

Patent Document 1 has proposed the use of an aggregated binding update message to enable multiple home addresses from one or more home agents to be installed, refreshed and deleted using a single Mobile IP signaling phase. The use of a single signaling instance enables the amount of signaling bandwidth and signaling state to be reduced as compared to using conventional Mobile IP messages. Authentications between end-to-end nodes are done with the aid of an Authentication, Authorization, and Accounting (AAA) server.

The Long Term Evolution (LTE) project being worked by the Third Generation Partnership Project (3GPP) is aimed at improving the current Universal Mobile Telecommunications System (UMTS) standards to suit the Fourth Generation (4G) mobile communications technology. A characteristic of the 4G networks is the shift from the existing circuit and packet switch network to an all-IP system. The all-IP system refers to a network that is based on using the Internet Protocol (IP) for communication and signaling. Thus, such shift in the system requires evolving the existing architecture of UMTS and this work is being handled by the Systems Architecture Evolution (SAE) in 3GPP. For cellular operators, the shift to 4G requires the consideration on how to support mobility of their subscribers in an all-IP system. Therefore, mobile IP is sorted by cellular operators as a potential candidate to meet their requirements. This implies that cellular operators would have a home agent (HA) located within their evolved system that handles the mobile IP signaling (e.g. CoA binding) to the mobile nodes of their subscribers.

Both Patent Document 2 and Patent Document 3 describe a scenario in which a mobile node (MN) with multiple interfaces (termed as multimode node) can achieve simultaneous connection in an all-IP system. In both prior arts, MN is a subscriber to a cellular operator that is providing mobility services to MN. MN has one interface connected to the cellular network (termed as home network). This home attached interface uses the home address (HoA) for communication. Concurrently, MN has another interface connected to the wireless local area network (WLAN) (termed as foreign network). This foreign attached interface uses the care-of address (CoA.WLAN) for communication. In order to allow MN to use both its home attached and foreign attached interfaces simultaneously, MN sends a single binding update (BU) to HA binding both the HoA and CoA as active route paths to MN. This action prompts HA to bind the HoA as a CoA entry in the binding cache entry (BCE) of MN, thereby allowing HA to utilize both the HoA and CoA route paths to MN.

Non-patent Document 4 proposes the use of a state cookie to verify the reachability of an alternate CoA within the binding update (BU) message. A mobile node (MN) sends the first BU with the alternate CoA option present to a correspondent (e.g. home agent). When the correspondent receives the BU, the correspondent would reject the BU by sending a binding acknowledgment (BA) message with a new dedicated status and a cookie option to the CoA specified in the alternate CoA option. Concurrently, the correspondent would temporarily disable the binding cache entry of MN. This implies that the correspondent would use the home address (HoA) of MN for communication until the alternate CoA has been verified. When MN receives the BA, MN would proceed to retransmit a second BU with cookie embedded in a cookie option to the correspondent. The correspondent checks the cookie in the second BU to see if it is the same as the one sent to MN via the alternate CoA. If so, the correspondent would have verified that the alternate CoA is reachable and accept the alternate CoA as the current CoA of MN.

Non-patent Document 5 proposes a mechanism for a correspondent node (CN) to verify the CoA specified in an early binding update (EBU) message from a mobile node (MN). The purpose of the EBU is to allow CN to create a tentative state for MN before verifying the care-of address of MN. Thus, CN maintains for each binding, an additional one-bit flag which corresponds to a state known as the “confirmed care-of address”. This state indicates whether or not the respective care-of addresses of MN are confirmed. If the “confirmed care-of address” state equals to “1”, this implies that the care-of address has been verified for its reachability. However, if the “confirmed care-of address” state equals to “0”, this implies that the care-of address has not been verified for its reachability. Non-patent Document 5 suggests that CN uses a mechanism called the care-of-address spot checks to periodically probe the presence of MN at a confirmed care-of address. Thus, CN would send an Internet Control Message Protocol (ICMP) echo request to the care-of address of MN and expect MN to reply back with an ICMP response to verify the reachability for that particular care-of address.

[Patent Document 1] O'NEILL, Alan, “METHODS AND APPARATUS FOR AGGREGATING MIP AND AAA MESSAGES”, PCT Patent Application Publication, WO 03/096592A2, May 2003.

[Patent Document 2] J. Bachmann, K. Weniger and R. Hakenberg, “Enabling simultaneous use of home network and foreign network by a mutihomed mobile”, PCT Patent Application Publication, WO 07/039016A1, 17 Aug. 2006.

[Patent Document 3] J. Hirano, C-W. Ng, B. Koh and P Y. Tan, “Mobile node and communication control method”, PCT Patent Application Publication, WO 07/007856A1, 7 Jul. 2006.

[Non-patent Document 1] D. Johnson, C. Perkins and J. Arkko, “Mobility Support in IPv6”, Internet Engineering Task Force Request For Comments 3775, June 2004.

[Non-patent Document 2] R. Wakikawa, T. Ernst and K. Nagami, “Multiple Care-of Addresses Registration”, draft-ietf-monami6-multiplecoa-00, Monami6 Working Group Internet-Draft, Jun. 12, 2006.

[Non-patent Document 3] M. Kuparinen, H. Mahkonen and T. Kauppinen, “Multiple CoA Performance Analysis”, draft-kuparinen-monami6-mcoa-performance-00, Network Working Group Internet-Draft, Apr. 20, 2006.

[Non-patent Document 4] F. Dupont, and J-M. Combes, “Care-of Address Test for MIPv6 using a State Cookie”, draft-dupont-mipv6-rrcookie-00, Internet Engineering Task Force Internet-Draft, Jan. 10, 2005.

[Non-patent Document 5] C. Vogt, J. Arkko, R. Bless, M. Doll and T. Kfner, “Credit-Based Authorization for Mobile IPv6 Early Binding Updates”, draft-vogt-mipv6-credit-based-authorization-00, Internet Engineering Task Force Internet-Draft, May 21, 2004.

However in all the above-mentioned prior arts (especially, Patent Documents 1-3 and Non-patent Documents 1-3), as MN and HA have already established mutual authentication, HA implicitly trusts the MN and thus is able to accept bulk registration. Nonetheless, this trust relationship means that a malicious MN can successfully bind a victim's address as its CoA at the HA without the HA verifying that the MN is using the stated CoA. Once the address has been bound, the malicious MN can perform a re-direction attack by instructing the HA to flood the victim's address with unnecessary packets.

For cellular operators, the establishment of a trust relationship between the operator and subscribers allows operators to provide services to subscribers. For example, the network would trust that the user operating a mobile node is the genuine subscriber and not someone else who has stolen the subscriber's identity. To strengthen this trust relationship, operators use the Authentication, Authorization, and Accounting (AAA) protocol within their system to authenticate their subscribers before providing services to them. Furthermore, a business contract between the operator and subscribers binds subscribers to obey the rules dictated by the operator when using the services provided by the operator. Such business contract will henceforth be known as terms and conditions. Using the terms and conditions, an operator is able to terminate services to a subscriber if the operator deems that the subscriber is acting unlawfully. Such unlawful action by the subscriber will henceforth be known as acting maliciously.

However, in the scenario when the mobile node (MN) is simultaneously attached to a cellular network and a WLAN network, MN can use bulk registration to bind the CoA.WLAN via the cellular network. For example, MN can send a BU via the home attached interface with its source address as the HoA and the alternate CoA as CoA.WLAN. Since the cellular network has already authenticated that MN is a trusted user in the cellular system, HA will accept the BU and bind the CoA.WLAN as an active route of MN. This reliance in trust by the HA may allow a malicious MN to bind a victim's CoA and perform the re-direction attack.

In addition to the previous mentioned problem, all nodes will trust the backbone infrastructure to correctly route their packets. This implies that when a node receives a message from another node stating its CoA as the source address, the receiving node trusts the routing infrastructure such that ingress filtering would have been performed at the sending node's current location. Thereby with ingress filtering, the receiving node can be assured that the incoming packets are actually from the networks that the packets claim to be from. Furthermore, the receiving node also trusts that packets received by the receiving node would be sent to the intended destination due to the routing processing in the routing infrastructure. Thus with nodes believing in the routing infrastructure, a CoA specified as a source address would be trusted by the receiving node. However, with the use of Alternate CoA within a Binding Update for Bulk Registration, the CoA is now specified in the BU. Therefore, such a trust relationship is lost between the sending node and the receiving node.

### DISCLOSURE OF THE INVENTION

It is thus an object of the current invention to provide a method for any nodes receiving the Bulk Registration to verify that the Mobile Node is indeed using a particular Care-of Address specified in a bulk registration.

The current invention provides a solution for the problem that has arisen during bulk registration when a Home Agent binds the alternate Care-of Addresses (CoAs) specified by the Mobile Node without verifying those CoAs claimed by the Mobile Node are in fact addressable. The aspect of the invention would be a method for Home Agents to achieve alternate CoAs verification, thus providing additional security against re-direction attacks invoked by malicious MN.

In one preferred embodiment of the present invention, it is provided a method of allowing the Home Agent to verify multiple CoAs within a Multimode Node's Bulk Binding Update (BBU) message comprising the step where the Home Agent tags all CoAs within the Multimode Node's BBU message as unverified. Furthermore, the verification method of the Multimode Node's CoA may either be the way the Home Agent receives a Binding Update (BU) message from the Multimode Node with the said unverified CoA as the source address or the Home Agent knows that the Multimode Node has received a Binding Acknowledgment (BA) message sent by the Home Agent to the said unverified CoA.

In another preferred embodiment of the present invention, it is provided a method of allowing the Home Agent to know if a Multimode Node has received a Binding Acknowledgment (BA) message sent by the Home Agent to the said Multimode Node unverified CoA comprising the following steps where: the Home Agent selects a first and second unverified CoA of a Multimode Node to test; the Home Agent sends a Binding Acknowledgment (BA) message to the Multimode Node through the said first unverified CoA, wherein the acknowledgment message contains a request to the Multimode Node to reply back to the Home Agent using the said second unverified CoA; the Multimode Node replies the Home Agent with a second BBU using the said second unverified CoA upon receiving the BA from the Home Agent; and the Home Agent verifies the addressability of both said first and second unverified CoAs after receiving the second BBU from the Multimode Node.

In yet another preferred embodiment of the present invention, it is provided another method of allowing the Home Agent to know if a Multimode Node has received a Binding Acknowledgment (BA) message sent by the Home Agent to the said Multimode Node unverified CoA comprising the following steps where: the Home Agent selects an unverified CoA of a Multimode Node to test; the Home Agent sends a Binding Acknowledgment (BA) message to the Multimode Node through said unverified CoA, wherein the acknowledgment message contains a reduced lifetime (low lifetime) as compared to initial lifetime proposed by the Multimode Node, thus forcing the Multimode Node to send a second BBU message; the Multimode Node replies the Home Agent with a second BBU using any of the Multimode Node CoAs in communication with the Home Agent upon receiving the BA from the Home Agent; and the Home Agent verifies the addressability of said unverified CoA after receiving the second BBU from the Multimode Node.

### BRIEF DESCRIPTION OF THE DRAWINGS

FIG. 1 is a diagram illustrating the preferred system according to a preferred embodiment of the current invention.

FIG. 2 is a diagram illustrating the preferred components of a Home Agent according to a preferred embodiment of the current invention.

FIG. 3 is a diagram illustrating the preferred message format of the Bulk Binding Update according to a preferred embodiment of the current invention.

FIG. 4 is a diagram illustrating a preferred binding entry for a Multimode Node stored at the Home Agent according to a preferred embodiment of the current invention.

FIG. 5 is a diagram illustrating a sequence diagram on the preferred method of performing the Care-of Address verification process between a Multimode Node and the Home Agent according to a preferred embodiment of the current invention.

FIG. 6 is a diagram illustrating the state diagram for the Care-of Address bindings at the Home Agent according to a preferred embodiment of the current invention.

FIG. 7 is a diagram illustrating the preferred system according to another preferred embodiment of the current invention.

FIG. 8 is a diagram illustrating a flow chart on the preferred method of how a home agent determines if the verification process is required according to another preferred embodiment of the current invention.

### BEST MODE FOR CARRYING OUT THE INVENTION

In the following description, for purposes of explanation, specific numbers, times, structures, protocol names, and other parameters are set forth in order to provide a thorough understanding of the present invention. However, it will be apparent to anyone skilled in the art that the present invention may be practiced ⁻without these specific details. In other instances, well-known components and modules are shown in block diagram in order not to obscure the present invention unnecessarily.

The present invention involves a Mobile IPv4 or Mobile IPv6 compliant Home Agent (HA) with capabilities of supporting Bulk Registration to verify the various route paths that are specified by a Multimode Node. For ease of explaining the present invention, the term “Bulk Registration” will henceforth be used to refer to a method of binding multiple care-of addresses to a single home address in a Binding Update (BU) message. This BU message will henceforth be known in this invention as a Bulk Binding Update (BBU) message. In addition, the term “Multimode Node” will henceforth be used to refer to any node (either a host or a router) with several IPv4 or IPv6 addresses to choose from. This implies that the node can be any combination of either receiving multiple prefixes advertised on the link(s) that it is attached to or having multiple interfaces to choose between, on the same link or not.

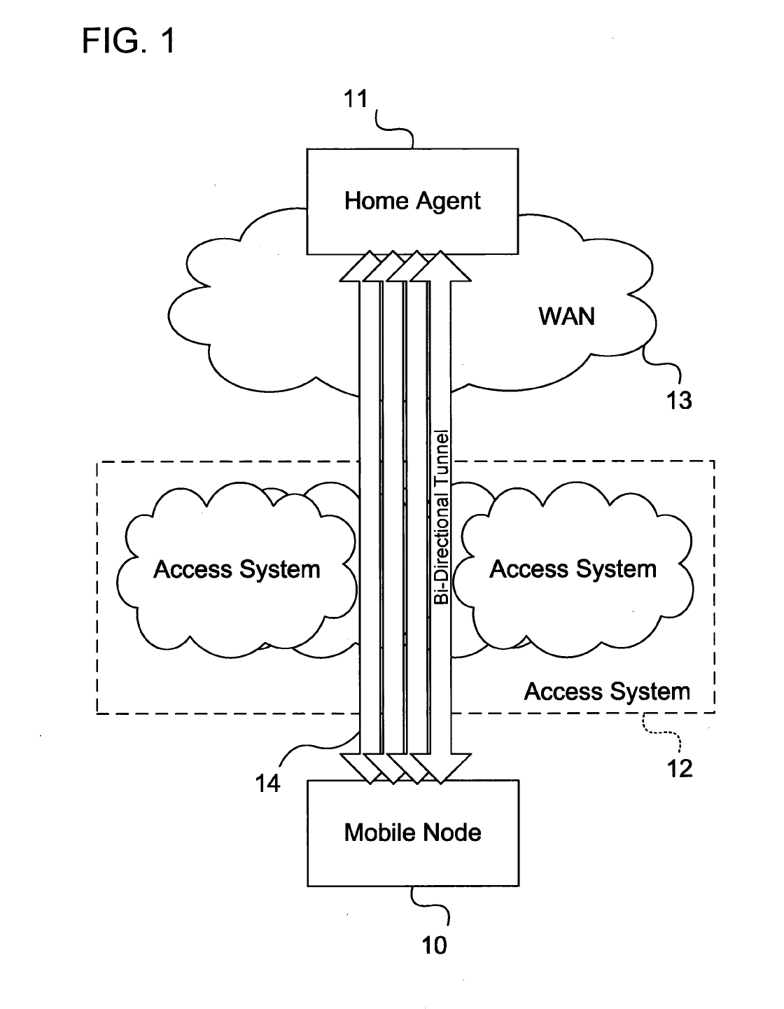

FIG. 1 shows the preferred system of the present invention. In this preferred system, Mobile Node (MN) 10 is a Multimode Node capable of having multiple Care-of Addresses (CoAs) over one or a plurality of same or different access systems 12. For such a preferred system, access system 12 may be, but not restricted to, Wi-Fi, Bluetooth or Cellular. Additionally, MN 10 has the functionality of sending or receiving messages to and from Home Agent (HA) 11 over the Wide Area Network (WAN) 13. In this preferred system, messages exchanged between MN 10 and HA 11 may well be, but not limited to, Bulk Binding Update (BBU) or Binding Acknowledgment (BA). In this present invention, BBU is transmitted from MN 10 to HA 11, which allows the binding of a plurality of CoAs to a single Home Address (HoA) of MN 10. In addition, BA is transmitted from HA 11 to MN 10, which informs MN 10 of the status of recent binding request.

With reference to the preferred system, messages exchanged between MN 10 and HA 11 are further transmitted securely over one or a plurality bi-directional tunnels 14 established between MN 10 and HA 11. The means of establishing the bi-directional tunnels between MN 10 and HA 11 in this preferred system may be achieved by using techniques such as, but not constrained to, Internet Key Exchange (IKE). HA 11 in this preferred system is a router capable of forwarding packets for MN 10 when it is away from the home network. Furthermore, HA 11 has the added functionality of processing messages it receives from MN 10. With reference to the preferred system, these messages may be, but not restricted to BBU sent from MN 10.

For such a preferred system, MN 10 may be, but not limited to, printers, personal computers, routers or other electronic peripherals. In addition, MN 10 may preferably be implemented as a mobile or fixed node. In this preferred system, we illustrate a Mobile Node 10 is in communication with HA 11. However, those skilled in the art would be aware that Mobile Node 10 can be a mobile router in communication with HA 11 and as such any functionality of MN 10 can also be applied to a mobile router.

Thus, it is an object of the invention with the previously specified preferred system that HA 11 would have a means to verify the CoAs within Bulk Binding Update (BBU) message from MN 10. For this preferred embodiment, HA 11 would tag any CoA that it receives from MN 10 as unverified. The process of HA 11 tagging may be, but not restricted to, HA 11 associating a flag with a CoA within the binding entry cache of HA 11. HA 11 can verify a CoA when it receives a binding message from MN 10 with the source address specified as the said CoA. Furthermore, with regards to our preferred embodiment, another method for HA 11 to verify an unverified CoA of MN 10 is for HA 11 to send the first binding message to the said unverified CoA and receive the second binding message from MN 10. The purpose of HA 11 sending the first binding message to an unverified CoA is to provide HA 11 some assurance that MN 10 is addressable at the said unverified CoA. With the receipt of the second binding message from MN 10, HA 11 is able to know that MN 10 has received the first binding message correctly. Thus, HA 11 is able to verify that MN 10 is addressable at the said CoA. The first binding message used in this preferred embodiment, may be, but not restricted to, a Binding Acknowledgment (BA) message. The second binding message used in this preferred embodiment, may be, but not limited to, a Bulk Binding Update (BBU) message or a Binding Update (BU) message.

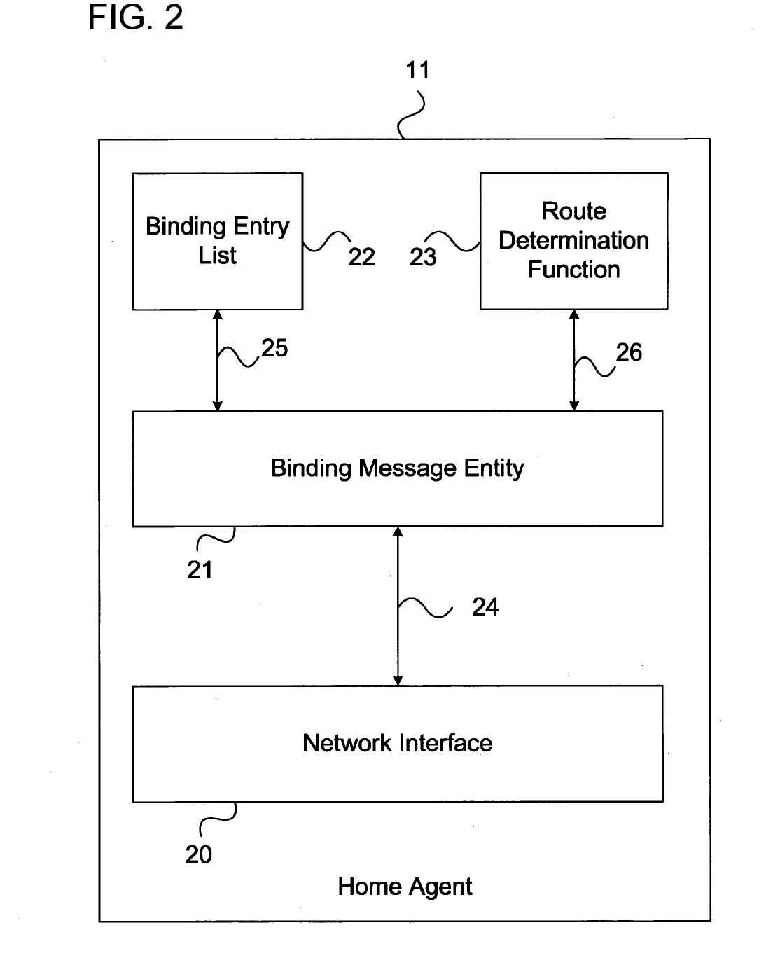

With the system as specified in the present invention, HA 11 is essentially provided with a simple yet effective mechanism for verifying the alternate CoAs specified by MN 10 during Bulk Registration. FIG. 2 shows the various preferred components of such a Home Agent, including a single or plurality of Network Interfaces 20, a Binding Message Entity 21, a Binding Entry List 22 and a Route Determination Function 23. The Network Interface 20 is a functional block that encompasses all the hardware and software necessary for HA 11 to communicate with another node via some communications medium. Using terminology well-known in the relevant field of art, a Network Interface 20 would represent communications components, firmware, drivers, and communications protocols of Layer 1 (Physical Layer) and Layer 2 (Data Link Layer) . A person skilled in the art would appreciate that the Home Agent may contain one or more Network Interfaces 20.

The Binding Message Entity 21 handles the processing of all binding messages sent and received at HA 11. In one preferred embodiment, binding messages may be, but not restricted to, Bulk Binding Update (BBU) or Binding Acknowledgment (BA) . The Binding Message Entity 21 allows HA 11 to process a BBU message received from any Multimode Node. In addition, the Binding Message Entity 21 also allows HA 11 to generate BA in response to the Multimode Node's BBU. The signal/data path 24 allows the Binding Message Entity 21 to receive and transmit packets from/to the appropriate Network Interface 20. Using terminology well-known in the relevant field of art, the Binding Message Entity 21 would represent the implementations of Layer 3 (Network Layer) protocols, such as Mobile Internet Protocol version 4 or 6.

To assist in the processing of the binding messages done at the Binding Message Entity 21, the Binding Entry List 22 contains the current bindings concerning any Multimode Node in communication with HA 11. If possible, the Binding Entry List 22 includes a list of binding entries, wherein each binding entry specifies a relationship between a single or plurality of the Multimode Node Care-of Addresses (CoAs) and one or a plurality of the Multimode Node Home Addresses (HoAs). In addition to this, for each binding entry, there exists a flag to indicate the assurance of addressability for the current binding CoA. In our preferred embodiment, a flag can be represented, but not limited to, setting two bits in the associated entry to ‘01’ for a verified CoA, ‘10’ for an unverified CoA or ‘11’ for testing an unverified CoA (i.e. during a period of testing an unverified CoA). The signal/data path 25 allows the Binding Message Entity 21 to update entries in and extract entries from the Binding Entry List 22.

The current invention introduces a Route Determination Function 23, which provides the mechanism to allow HA 11 to select an unverified CoA from a Multimode Node binding entry for the testing of the CoA's addressability. The purpose of this testing is so that when Bulk Registration is performed by the Multimode Node, the Home Agent can be assured that those alternate CoAs specified by the Multimode Node is addressable. The signal/data path 26 allows the Binding Message Entity 21 to send binding entries with an unverified CoA to the Route Determination Function 23 for the selection of an unverified CoA to test. Furthermore, the signal/data path 26 allows the Route Determination Function 23 to inform the Binding Message Entity 21 of which unverified CoA to test. The Route Determination Function 23 has key functions for achieving the present invention. The Route Determination Function 23 has various unit, for example, for marking each binding entry as verified, unverified or verification to manage the verification state of each address, for verifying addressability for an address in a binding entry marked as unverified, for changing the verification state of the address used as the source address of a packet from MN 10 into verified, for changing the verification state of the address used by the destination address of a packet sent to MN 10 into verified if HA 11 surely grasps that the packet has arrived at MN 10, for choosing an unverified CoA of MN 10 and placing the chosen CoA at the test CoA option embedded into a message to MN 10 (e.g. BA message), etc.

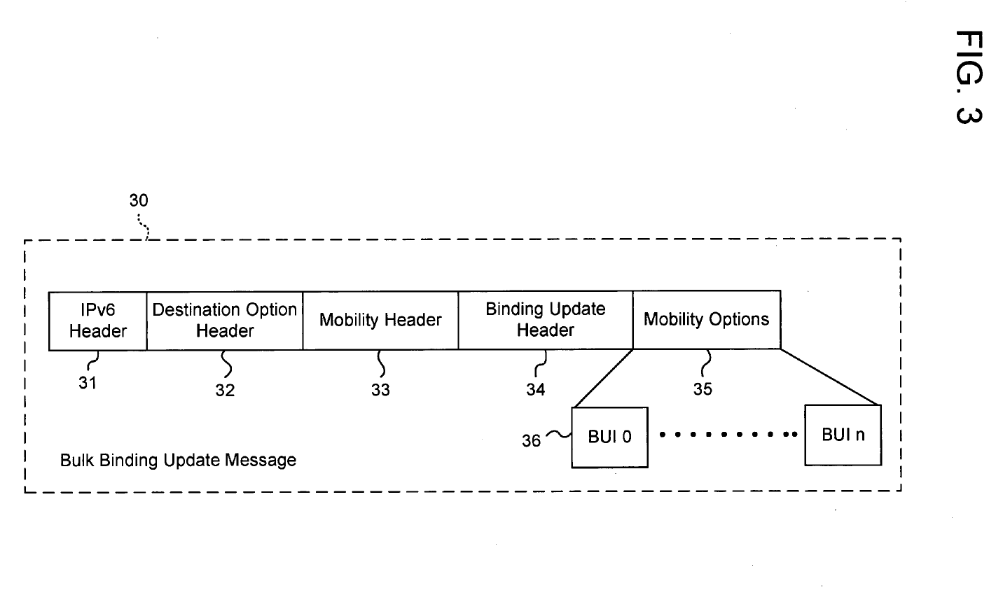

Bulk registration is an optimization method for registering multiple Care-of Addresses to a Home Agent by using a single Binding Update, as compared to registering multiple Care-of Addresses separately by a Multimode Node. This single aggregated Binding Update is known as a Bulk Binding Update (BBU) for this invention. FIG. 3 illustrates the message format of the Bulk Binding Update according to our preferred embodiment of the present invention. This message format is similar to the BBU message format stated in the Internet draft “Multiple CoA Performance Analysis” Non-patent Document 3. For this embodiment, BBU 30 includes an IPv6 Header 31, a Destination Option Header 32, a Mobility Header 33, a Binding Update Header 34 and a Mobility Options 35. The IPv6 Header 31 is in the first forty octets of the packet and contains both source and destination addresses (128 bits each) , as well as the version (4-bit IP version) , traffic class (8 bits, Packet Priority) , flow label (20 bits, QoS management), payload length (16 bits), next header (8 bits), and hop limit (8 bits, time to live) . The payload can be up to 64k in size in standard mode, or larger with a “jumbo payload” option. With the presence of options, the Next Header field specifies the presence of an extra options header, which then follows the IPv6 header.

The Destination Option Header 32 is used to carry optional information that need be examined only by a packet's destination node(s). For this preferred embodiment, the Destination Option Header 32 contains the Home Address, which is used to allow a Mobile Node while away from home, to inform the recipient of the Mobile Node's home address. The Mobility Header 33 is an extension header used by Mobile Nodes, Correspondent Nodes, and Home Agents in all messaging related to the creation and management of bindings. The Mobility Header 33 contains a Mobility Header Type (8 bits) that identifies the particular mobility message in question. In our preferred embodiment, the Mobility Header Type (MH Type) value is set to five, for example, indicating that the message is a Binding Update (BU) message.

The Binding Update Header 34 contains the necessary information to allow a Mobile Node to notify other nodes of a new care-of address for itself. With regards to our preferred embodiment, the Mobility Options 35 contain one or a plurality of Binding Unique Identifier (BUI) sub-options 36, which are used by the Mobile Node when sending BUs. In our preferred embodiment, the Mobile Node can specify one or more Binding Unique Identifier sub-options 36 in a single BU message, thereby allowing the Mobile Node to perform Bulk Registration by embedding CoAs to be bound in BUI sub-options 36.

When the HA 11 receives a Bulk Binding Update (BBU) from MN 10, the Binding Message Entity 21 performs the authentication procedure to validate that the BBU is sent from MN 10. In this preferred embodiment, the authentication procedure may be, but not limited to verifying a pre-shared key negotiated previously between HA 11 and MN 10. Upon validating the BBU, the Binding Message Entity 21 checks if an existing entry for MN 10 is present in the Binding Entry List 22. For this preferred embodiment, the process of checking may comprise, but not restricted to, checking if the source address of the BBU is already bound to the HoA specified in the Destination Options Header. In yet another preferred embodiment, the process of checking may be, but not limited to checking if the CoA in the Binding Unique Identifier sub-options is already bound to the HoA specified in the Destination Options Header. In one embodiment, if the entry is present, the Binding Message Entity 21 updates the current entry with the new entry it received. Meanwhile, if the entry is not present, the Binding Message Entity 21 creates a new entry for the new binding and stores it within the Binding Entry List 22.

With the entry either updated or created, the Binding Message Entity 21 will next determine if the recent binding is for an Alternate CoA or for a CoA specified in the source address of the BBU. In one embodiment, if the binding is for an Alternate CoA, the Binding Message Entity 21 adds an unverified flag to the binding entry. The purpose of adding an unverified flag is to let HA 11 know that the CoA has not been tested yet for its addressability. In this preferred embodiment, an unverified flag can be represented by, but not limited to, setting two bits in the associated entry to ‘10’. Meanwhile, if the binding is for a CoA specified in the source address of the BBU, the Binding Message Entity 21 adds a verified flag to the binding entry. The purpose of adding a verified flag is to let HA 11 know that the CoA has been already tested for its addressability. In this preferred embodiment, a verified flag can be represented by, but not limited to, setting two bits in the associated entry to ‘01’.

After the binding of one CoA, the Binding Message Entity 21 checks the BBU to decide if there are more CoAs to be bound. In this preferred embodiment, the checking of the BBU may include, but not restricted to, determining if there are any other Binding Unique Identifier sub-options present in the BBU. In one preferred embodiment, if there are more CoAs present in the BBU to process, the Binding Message Entity 21 continues to process the remaining CoAs with the steps stated in the previous embodiments. Once the Bulk Binding Update registration process is completed, the binding entry for MN 10 would be stored in the Binding Entry List 22.

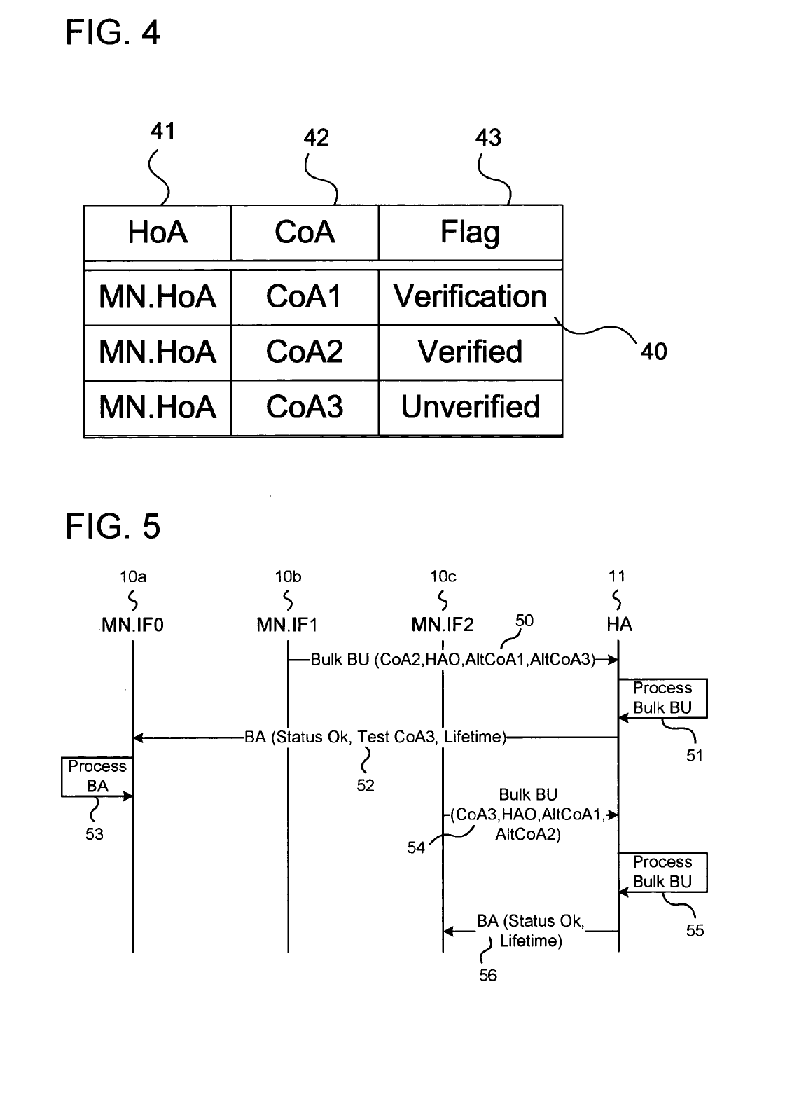

FIG. 4 shows a binding entry for a Multimode Node stored at the Home Agent according to preferred embodiment of the present invention. In this preferred embodiment, binding entry 40 includes a HoA column 41, a CoA column 42 and a Flag column 43. In our preferred embodiment, the HoA column 41 contains the Home Address of MN 10, which was specified in the Destination Header Options 32 of BBU 30. The HoA would be bound to one or a plurality of CoAs to allow MN 10 to be contacted even if it is away from the home domain.

The CoA column 42 contains the various Care-of Addresses that MN 10 specified to be bound to its HoA during the Binding Update procedure. In this preferred embodiment, the CoA may be, but not limited to, the source address of BBU 30 or the CoA located within BUI 36. The CoA allows HA 11 to route packets meant for MN 10 when it's not currently connected to home domain. The Flag column 43 specifies if the particular CoA has been verified for its addressability. According to our invention, unverified CoAs are required to be verified through the verification process before being used as a valid route path to MN 10. In our preferred embodiment, a flag can be represented, but not limited to, setting two bits in the associated entry to ‘01’ for a verified CoA, ‘10’ for an unverified CoA or ‘11’ for verification of CoA (i.e. during verification).

According to our preferred embodiment, once all the CoAs specified in the BBU has been processed and stored in the Binding Entry List 22, the Binding Message Entity 21 proceeds to decide if a verification process for the unverified CoAs is to be done. In our preferred embodiment, the decision of the verification process may be, but not restricted to, checking from a user policy stored at HA 11 to determine if the user wishes to verify all CoAs during the receipt of a BBU. If it is determined to perform the verification process, the Binding Message Entity 21 triggers the Route Determination Function 23 to perform the process of selecting an unverified CoA to test for its addressability. On the other hand, if it is determined that the verification process would not be perform at that current moment, the Binding Message Entity 21 ends the process of registering the BBU by sending to MN 10 a Binding Acknowledgment (BA) stating the status of MN 10 bindings.

The CoA verification process provides the Home Agent with some reasonable assurance that the Multimode Node is in fact addressable at its claimed CoA as well as at its HoA. In our preferred embodiment, a trigger permits the HA 11 to start the CoA verification process. In this preferred embodiment, the trigger is the receipt of a BBU from MN 10, which allows HA 11 to process the verification immediately. When verification is done immediately, it enables HA 11 to optionally re-direct traffic to any of the verified CoAs of MN 10 in the event that a traffic flowing through an interface has been unexpectedly disconnected. In such a case, it is better to ensure that all of the CoAs of MN 10 are verified to allow for a smooth re-directing of traffic.

In another preferred embodiment, the trigger is the requirement of HA 11 to send a traffic flow through an unverified CoA path to MN 10, which allows HA 11 to process the verification at a later point in time, henceforth this verification method will be known in this invention as delayed verification. For this embodiment, the requirement may be, but not limited to, the need for MN 10 to filter its various traffic flows at HA 11, henceforth this filtering method will be known in this invention as flow filtering. When delayed verification is performed, it provides HA 11 with the means to test an unverified CoA of MN 10 only before the said unverified CoA is to be used. This is especially true when HA 11 is in communication with multiple Multimode Nodes and constant immediate verification for all the Multimode Nodes would overload HA 11, thus reducing the processing efficiency of HA 11.

For our preferred embodiment, we illustrate that HA 11 can perform either the immediate or delayed verification of MN 10 CoA. However, it will be apparent to anyone skilled in the art that HA 11 can be implemented to perform immediate verification for some of the Multimode Nodes and delayed verification for other Multimode Nodes. In addition, if one Multimode Node uses multiple CoAs, HA 11 can perform immediate verification for some of the CoAs and delayed verification for other CoAs. This allows available CoAs of MN 10 to be chosen based on the priority of the data flows (or the filter configuration), thereby the verification can be achieved with both stability and readiness.

FIG. 5 illustrates a sequence diagram on the preferred method of performing the Care-of Address verification process between a Multimode Node and the Home Agent according to a preferred embodiment of the invention. Here, MN 10 has three interfaces, namely, MN.IF0 10a, MN.IF1 10b and MN.IF2 10c, which are associated respectively to one CoA each, namely CoA1, CoA2 and CoA3. MN 10 sends a Bulk Binding Update (BBU) to HA 11 through MN.IF1 10b in step 50. The BBU includes a source address (CoA2), a Home Address located in the Home Address Option (HAO), and Alternate Care-of Addresses CoA1 and CoA3 (A1tCoA1 and AltCoA3) for MN.IF0 10a and MN.IF2 10c respectively. When HA 11 receives the BBU in step 50, HA 11 validates that the BBU is sent from MN 10 in step 51. For this preferred embodiment, the step of validating includes the authentication procedure and the updating or creation of the binding entry for MN 10. The various implementation steps for the validation process have been discussed in the previous embodiments.

HA 11 decides that the CoA verification process is to be done at the receipt of the BBU and thus the Route Determination Function 23 is triggered by the Binding Message Entity 21 for the selection of an unverified CoA to test. For this preferred embodiment, the Route Determination Function 23 obtains MN 10 binding entry from the Binding Message Entity 21 containing MN 10 CoAs along with the state of each CoA. In this preferred embodiment, the state of each CoA may be, but not limited to, an unverified state and a verified state. The Route Determination Function 23 chooses two unverified CoA to test, namely CoA1 and CoA3. In our preferred embodiment, an acknowledgment message is sent to CoA1, which includes a request for MN 10 to send a reply using CoA3. The Route Determination Function 23 sends a trigger to the Binding Message Entity 21 containing CoA1 and CoA3. For this preferred embodiment, the trigger may be, but not restricted to, such that the Route Determination Function 23 tells the Binding Message Entity 21 to test CoA3 via CoA1.

Once the Binding Message Entity 21 receives the trigger, it notices the CoA that is being tested and updates MN 10 binding entry. In our preferred embodiment, the Binding Message Entity 21 changes the flag for CoA1 from unverified to verification. The Binding Message Entity 21 proceeds to generate the Binding Acknowledgement (BA) message and sends it to MN.IF0 10a in step 52. According to our preferred embodiment, the BA sent in step 52 may contain, but not limited to, a status field. The status field indicates if the Bulk Registration initiated by MN 10 was accepted or rejected by HA 11. Furthermore with regards to our preferred embodiment, the BA sent in step 52 may further contain a test CoA option. The test CoA option is a request for Multimode Node in communication with HA 11 to reply via a stated CoA chosen by HA 11. For the present example, the stated CoA chosen by HA 11 is CoA3. It is assumed in this example that MN 10 understands the test CoA option within the BA message and thus would reply to HA 11 via CoA3. In this case, MN 10 need to be modified so as to have functional units for checking that the received BA message contains the test CoA option, and for sending the requested message to HA 11 via the interface which is associated with the CoA specified by the test CoA option.

With regards to our preferred embodiment, the BA sent in step 52 may contain, but not restricted to, a lifetime option. The lifetime option informs the Multimode Node in communication with HA 11 of how long the binding would remain valid. According to our preferred embodiment, when the lifetime of a particular binding for MN 10 is about to expire, MN 10 would send a binding message to HA 11 to update that said particular binding. In addition, when the lifetime of a particular binding for MN 10 is about to expire, HA 11 would send a binding refresh request to MN 10 informing it to update the said particular binding.

According to another embodiment for the invention, MN 10 may not have an ability to understand the test CoA option. In this embodiment, HA 11 can know that MN 10 is not able to understand the test CoA option, but not limited to, by the failure to receive a binding message from MN 10 within a stipulated time. Furthermore for this embodiment, the setting of the stipulated time may be, but not restricted to, the Binding Message Entity 21 setting a timer using the internal clock when BA is sent in step 52. For such a preferred embodiment, HA 11 sets the lifetime of the bindings initiated by MN 10 during the Bulk Registration to low and resends BA (BA sent in step 52) to MN 10. The purpose of setting the lifetime to low is to trigger MN 10 to send another BBU for the CoA verification process. The advantage of using the lifetime is to allow a Multimode Node that is not modified to understand the test CoA option to also perform the CoA verification process as stated in our invention. Such method of CoA verification is very much similar to the Binding Refresh Request (BRR) methodology described in Non-patent document 1.

In the above description, we illustrate that HA 11 can either use the test CoA option or lifetime with the Binding Acknowledgment (BA) message for the CoA verification process. However, it will be apparent to anyone skilled in the art that an implementation can combine the two into one, so that HA 11 need not know whether MN 10 understands the new option or not.

The purpose for which the Home Agent places the test CoA option and lifetime together within the BA ensures that the Multimode Node will reply back to the Home Agent as soon as the Multimode Node receives the BA, regardless of whether the Multimode Node understands the test CoA option or not. For example, according to our embodiment, it could be that MN 10 does not understand the test CoA option within the BA sent by HA 11 in step 52. In this case, since the status field within BA sent in step 52 states that the binding was accepted, MN 10 assumes that HA 11 has accepted the bindings within the BBU sent in step 50 and does not respond back to HA 11 using the CoA specified in the test CoA option. As HA 11 has set a stipulated time for the receipt of a binding message from MN 10 after sending BA in step 52, this time will expire and thus HA 11 would then know that MN 10 does not understand the test CoA option within BA sent in step 52. To resume the verification process, HA 11 sends MN 10 another Binding Acknowledgment stating the lifetime of MN 10 bindings as expiring. This delay within the verification process may not be acceptable as it may delay the sending of a traffic flow to MN 10 through the unverified CoA path. Furthermore, the delay incurred during the verification mechanism may force HA 11 to drop packets meant for MN 10 as HA 11 is unable to buffer anymore packets for MN 10. An example is that MN 10 sets a filter at HA 11 specifying that a video flow from a Correspondent Node (CN) would be routed through CoA3, which according to our preferred embodiment is currently unverified. The video flow is sent from the CN using User Datagram Protocol (UDP) as its transport protocol, which does not provide the reliability and ordering guarantees as that of Transmission Control Protocol (TCP). When HA 11 receives the video flow, HA 11 notices that CoA3 is currently unverified and proceeds to perform the verification mechanism with MN 10 while buffering the video flow. However, as MN 10 is unable to understand the test CoA option within BA sent in step 52, this causes a delay in verifying CoA3 which may result in HA 11 buffer becoming full. Thus, incoming packets received from the CN for MN 10 would be dropped as the buffer for HA 11 is full before CoA3 has been verified.

When MN 10 receives BA sent in step 52 from HA 11, it processes the BA in step 53. MN 10 notices from the test CoA option that HA 11 requests MN 10 to send a response back to HA11 via MN.IF2 10c. Furthermore, MN 10 also identifies that the lifetime for its current bulk binding is expiring and is required to send another Bulk Binding Update to HA 11. MN 10 proceeds to send a Bulk Binding Update (BBU) to HA 11 through MN.IF2 10c in step 54. In this preferred embodiment, the BBU includes a source address (CoA3), a Home Address located in the Home Address Option (HAO), and Alternate Care-of Addresses CoA1 and CoA2 (AltCoA1 and AltCoA2) for MN.IF0 10a and MN.IF1 10b respectively. When HA 11 receives the BBU in step 54, HA 11 validates the BBU which is sent from MN 10 in step 55. For this preferred embodiment, the step of validating includes the authentication procedure and the updating or creation of the binding entry for MN 10. The various implementation steps for the validation process have been discussed in the previous embodiments.

The Binding Message Entity 21 notices that the BBU is received from CoA3 and thus updates MN 10 binding entry in the Binding Entry List 22. Updating of MN 10 binding entry means that the Binding Message Entity 21 changes the flag for CoA3 from unverified to verified. Furthermore, updating of MN 10 binding entry also can lead the Binding Message Entity to changing the flag for CoA1 from verification to verified, as it understands that MN 10 has responded to its request to the test message, i.e. that MN 10 has responded to BA sent to CoA1. From MN 10 binding entry, the Binding Message Entity 21 detects that all bindings have been verified and thus the CoA verification process is completed. In our preferred embodiment, the Binding Message Entity 21 generates a final Binding Acknowledgment and sends it to MN 10 in step 56. For this preferred embodiment, BA 56 may contain, but not limited to, a status field and a lifetime field. According to our preferred embodiment, BA sent in step 56 informs MN 10 that all bindings have been registered successfully with the requested lifetime of the bindings as stated by MN 10.

In another preferred embodiment of CoA verification process, MN 10 is not modified to understand the test CoA message sent via HA 11. However, as the lifetime of the MN 10 bulk binding is set to low, MN 10 sends another BBU to HA 11 to register its CoAs specified in its previous BBU. For this embodiment, suppose MN 10 sends the BBU via an interface with its CoA that has already verified at HA 11, in this case CoA2. Since HA 11 receives the BBU, it implies that MN 10 could receive the BA that HA 11 has previously sent to CoA1 and thus allows CoA1 to be verified. In this preferred embodiment, the Binding Message Entity 21 changes the flag for CoA1 from verification to verified accordingly. in MN 10 binding entry stored at the Binding Entry List 22. HA 11 would then continue the CoA verification process to verify CoA3 as it's the last remaining unverified entry stated in this preferred embodiment.

In yet another preferred embodiment, each of MN 10 CoA binding entry at HA 11 is reflected as a unique binding identifier within the Binding Entry List 22 of HA 11. Such a unique binding identifier could be similar to the Binding Identifier (BID) as described in Non-patent document 2. Thus, HA 11 could send a binding message to MN 10 indicating the status of each of the CoA binding within the Binding Entry List 22 of HA 11. Such a binding message could be, but not restricted to, a binding acknowledgment message or a binding refresh request message. To indicate the status, the binding message reflects each BID entry as a Binding Unique Identifier (BUI) option. Furthermore, a flag would be associated to each BUI option to allow HA 11 to indicate to MN 10 the status of each CoA binding entry within the Binding Entry List 22 of HA 11. With such information, MN 10 now knows which CoAs entries at HA 11 have yet been verified. Hence, MN 10 can choose to send a data packet through the unverified CoA path to HA 11. This permits HA 11 to update the binding entry of MN 10 in its Binding Entry List 22 to reflect it as verified.

The following example will be illustrated in order to provide this method with more clarity. Referring to FIG. 5, HA 11 receives BBU 30 from MN 10 (in step 50) . In BBU 30, MN 10 links each CoA with a unique BID. For example, CoA1 is linked to BID1, CoA2 to BID2 and CoA3 to BID3. For this embodiment, HA 11 is performing a delayed verification process. Thus, HA 11 sends a binding acknowledgement (BA) message to MN 10 and uses flags to indicate the status of each binding of MN 10 (in step 52). For example, HA 11 indicates in the BA that BID1 is verified, BID2 and BID 3 is unverified. In our preferred embodiment, a flag can be represented, but not limited to, setting two bits in the associated entry to ‘01’ for a verified CoA, ‘10’ for an unverified CoA or ‘11’ for testing an unverified CoA (i.e. during a period of testing an unverified CoA). With the reception of the BA at MN 10, MN 10 would know the status of each of its CoA binding at HA 11. Thus, if MN 10 wants to change the status of BID2 to “verified” at HA 11, MN 10 sends a data packet to HA 11 via CoA2. Such an action allows HA 11 to verify that MN 10 is addressable at CoA2.

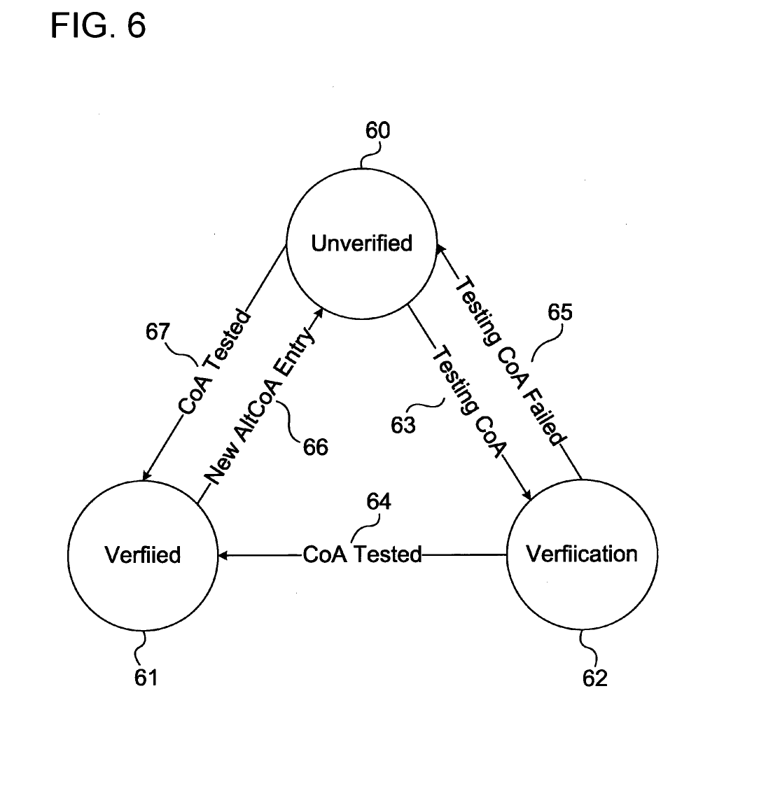

FIG. 6 shows the state diagram for the CoA bindings at the Home Agent for our preferred embodiment. In this preferred embodiment, HA 11 includes three states within its Binding Entry List 22, which are a Unverified state 60, a Verified state 61 and a Verification state 62. The Unverified state 60 is the state in an entry that denotes that the CoA entry has not been tested for its addressability. In our preferred embodiment, for entries with this state, HA 11 would not route any packets for MN 10 through the untested CoA until that particular route path has been verified. When the Binding Message Entity 21 receives the instruction to test an unverified CoA, it proceeds with the CoA verification process as mentioned in our previous embodiments. In our preferred embodiment, this triggers the Testing CoA 63 signal and moves the state of the CoA entry from the Unverified state 60 to the Verification state 62. Furthermore, once the CoA verification process is completed for a CoA entry in the Verification state 62, this triggers the CoA Tested 64 signal and moves the state of the CoA entry from the Verification state 62 to the Verified state 61.

A CoA entry that has not been tested for its addressability will be placed in the Unverified state 60. However, if MN 10 would to send a BBU or BU with its source address similar to the CoA entry, this would imply that the particular CoA has been tested for its addressability. In our preferred embodiment, this triggers the CoA Tested 67 signal and moves the state of the CoA entry from the Unverified state 60 to the Verified state 61.

The Verification state 62 is the state in an entry that denotes that the CoA is currently being tested for its addressability. In our preferred embodiment, a CoA entry that is currently undergoing the steps of the CoA verification process as stated in our previous embodiments. When the CoA entry is currently in the Verification state 62 and it fails to verify its addressability, the CoA is deem non addressable. In our preferred embodiment, this triggers the Testing CoA Failed 65 signal and moves the state of the CoA entry in that particular binding from the Verification state 62 to the Unverified state 60.

The Verified state 61 is the state in an entry that denotes that the CoA has been tested for its addressability. CoA included in the source address of a BBU or a BU automatically places that entry in the Verified state 61. When a BBU is received by HA 11 containing a BUI stating the CoA entry specified in the Verified state 61, this means that MN 10 is performing Bulk Registration for that particular CoA. This triggers the New AltCoA Entry 66 signal and moves the state of the CoA entry in that particular binding from the Verified state 61 to the Unverified state 60.

In another preferred embodiment of the CoA verification process, the trigger is the requirement of HA 11 to send a traffic flow through an unverified CoA path to MN 10. MN 10 has set active flow filter parameters at HA 11, which allows HA 11 to route traffic destined to MN 10 via the filters MN 10 has created. Filters denote the binding of flow parameters to one or a plurality of MN 10 CoAs. Furthermore, flow parameters may be, but not limited to a Correspondent Node source address or port numbers. When HA 11 receives a flow destined to MN 10, it checks the flow parameters against the filters defined for MN 10. HA 11 identifies MN 10 has specified to route the flow through an unverified CoA and triggers a CoA verification process to test the CoA for its addressability before sending the flow through the particular CoA route path. HA 11 can use the CoA verification process stated in our invention as described in the previous embodiments. It should be obvious to a person skilled in the art that HA 11 can use other messages to test reachability, such as sending an ICMP echo request packet to unverified CoA of MN 10 to test the said unverified CoA for its addressability. When HA 11 receives an ICMP echo response packet from MN 10 with the said CoA, the test for addressability is completed and HA 11 can route the flow through the said CoA path.

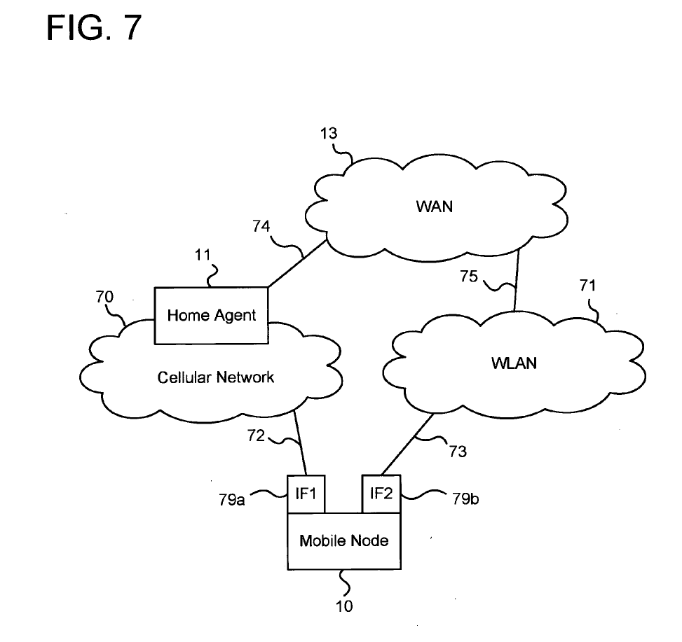

Furthermore, in another preferred embodiment of the invention, the verification method performed by HA 11 can also be applied in a cellular scenario (such as in a 3GPP network). FIG. 7 is a diagram illustrating another preferred system according to another preferred embodiment of the current invention. In this system, MN 10 is a subscriber of a cellular operator, and the cellular operator provides mobility services to MN 10. Thus, HA 11 located within the operator's cellular network 70 processes all mobility related signaling for MN 10. MN 10 has a cellular interface 79a that is connected via path 72 to the cellular network 70, which is the home network for MN 10. The cellular interface 79a is using the home address (HOA) for communication. Concurrently, MN 10 has a WLAN interface 79b that is associated via path 73 to the WLAN 71. As the WLAN 71 is not part of the operator's network, it is deemed to the operator that the WLAN 71 is a foreign network. The WLAN interface 79b is using the care-of address (CoA.WLAN) for communication. MN 10 performs methods described in prior arts to utilize both interfaces for communications. As such, HA 11 would have two binding entries for MN 10. The first binding entry would contain information on routing packets to the HoA of MN 10 via path 72. The second binding entry would contain information on routing packets to the CoA of MN 10 via path 73. For the second binding entry, HA 11 would route packets via path 74 to WAN 13, in which packets will be routed in turn to WLAN 71 via path 75.

In FIG. 7, MN 10 can use bulk registration to send a BBU 30 to HA 11 via the cellular interface 79a. For this embodiment, the BBU may include, but not limited to, the HoA as source address in the IPv6 Header 31 and the CoA.WLAN in the BUI option 36. As there is a trust relationship established between the cellular network 70 and MN 10, HA 11 would trust the authenticity of BBU 30 and bind such CoA.WLAN as a verified routing path to MN 10. By virtue of this action, it may allow a malicious subscriber to perform a re-direction attack for such a system. As such, the use of bulk registration does not seem to be a desired feature for cellular operators as it could lead to a misuse of the trust the operators gives to subscribers.

However, the benefit of bulk registration in optimizing the mobility signaling between mobile nodes and home agent is a desired feature that cellular operators seek in order to enhance the mobility services provided to subscribers. For example, MN 10 could use techniques such as Fast Mobile IP (FMIP) to obtain a CoA from the second WLAN that MN 10 is roaming to. Normally, for MN 10 to bind the CoA at HA 11, the WLAN interface 79b has to successfully associate with the second WLAN first before a BU can be sent to HA 11. There might be cases in which, the time taken to associate might be longer than expected and thus, this causes a delay in sending out the mobility signaling messages (e.g. BU). As cellular operators are attempting to reduce the amount of delay experienced by subscribers during roaming, bulk registration can be seen as a potential candidate for such matter. Taking the previous example, MN 10 can use bulk registration to send a BU via the cellular interface 79a to bind the CoA that was obtained using FMIP. This process reduces the amount of signaling delay that maybe experience by MN 10.

Therefore, in order to strengthen the trust relationship between subscribers and operators and to prevent the misuse of the operator's trust, it is likely that operators would implement policies at the home agent to verify addresses specified in the BBU before binding. Thus, it is possible for cellular operators to use the methods of the present invention to allow a home agent to verify the addresses specified in the BBU before binding the route path for a mobile node. In yet another preferred embodiment of the invention, it is possible that cellular operators implement a policy at the home agent to only perform the verification methods of the present invention only if the address specified in the BBU is not configured from a prefix trusted by the cellular operator.

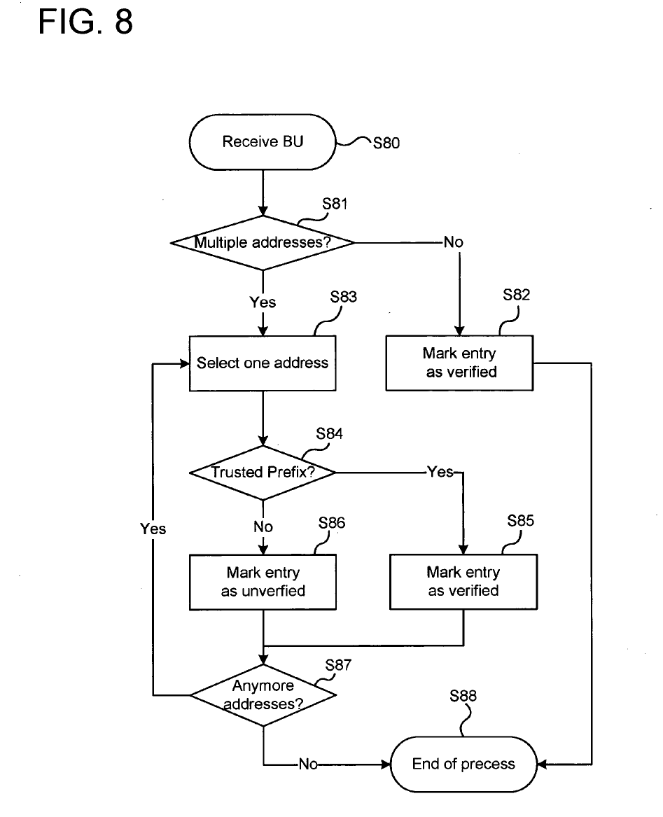

FIG. 8 highlights a flow chart diagram illustrating a preferred method of how a home agent determines if the verification process is required according to a preferred embodiment of the current invention. The process starts (step S80) when HA 11 receives a binding update (BU) message from MN 10. This prompts HA 11 to check if the BU is meant to bind a plurality of CoAs for MN 10, for example, if the BU is a bulk registration BU (step S81). If the BU only contains a single CoA for binding, HA 11 continues to store the CoA as a binding entry for MN 10 and marks the state of that entry as verified (step S82). With the state of the entry marked, HA 11 proceeds to end this determination process (step S88) and waits for another BU to trigger this process again.

However, if the BU contains a plurality of CoAs for binding, HA 11 proceeds to begin checking if the CoAs are required to be verified. HA 11 starts by selecting one address from the pool of CoAs in the BU (step S83) and proceeds to determine if the selected CoA is configured from a prefix trusted by the cellular operator (step S84). If the selected CoA is configured from a trusted prefix, HA 11 continues to store the selected CoA as a binding entry for MN 10 and marks the state of that entry as verified (step S85). This step (step S85) will be described in more detail with reference to the following example.

Suppose MN 10 has the third interface known as the General Packet Radio Switch (GPRS) interface. The GPRS interface is connected to a GPRS network owned by the operator of cellular network 70. MN 10 configures a care-of address (CoA.GPRS) using a trusted prefix advertised by the cellular operator for communication over the GPRS interface. As the GPRS interface has a limited amount of bandwidth for uplink, MN 10 decides to use bulk registration to bind CoA.GPRS at HA 11 via the cellular interface 79a. When HA 11 receives the BU from MN 10, HA 11 identifies that CoA.GPRS is configured from a trusted prefix of the cellular operator. Thus, HA 11 would bind CoA.GPRS as a verified route path to MN 10 without performing the verification methods based on the previously described embodiments.

In the event when the selected CoA is not configured from a prefix trusted by the cellular operator, HA 11 proceeds to store the selected CoA as a binding entry for MN 10 and marks the state of that entry as unverified (step S86). This step (step S86) will be described in more detail with reference to the following example. Suppose MN 10 uses bulk registration to bind CoA.WLAN at HA 11 via the cellular interface 79a. When HA 11 receives the BU from MN 10, HA 11 identifies that CoA.WLAN is not configured from a prefix trusted by the cellular operator. Thus, HA 11 would bind CoA.WLAN as an unverified route path to MN 10. In one embodiment, the method used to verify the reachability of CoA.WLAN may preferably be the way that HA 11 sends a binding acknowledgment (BA) to MN 10 asking MN 10 to reply via CoA.WLAN. If HA 11 receives a packet from MN 10 via CoA.WLAN, HA 11 marks in its binding entry that the CoA.WLAN route path is now verified. In yet another preferred embodiment of the invention, the method used to verify the reachability of CoA.WLAN could preferably be the way that HA 11 sends an Internet Control Messaging Protocol (ICMP) echo request to CoA.WLAN. This forces MN 10 to reply back an ICMP echo response via CoA.WLAN. Thus, HA 11 can now verify that MN 10 is reachable via CoA.WLAN and marks in its binding entry that the CoA.WLAN route path is now verified.

Once the selected CoA has been stored in the binding entry at HA 11, the determination process for HA 11 continues by checking if there are anymore CoAs in the BU that are required to be processed (Step S87). If there remains another CoA to be processed, HA 11 repeats the steps from step S83 to determine the state of each CoA binding for MN 10. If there are no more CoAs to be processed for the BU, HA 11 ends this determination process (step S88).

In yet another preferred embodiment of the invention, the cellular network 70 can further have a packet data gateway (PDG). The purpose of the PDG is to allow access into the cellular network 70 by a mobile node from WLAN 71. Thus, the PDG acts as a gateway for MN 10 to gain access into the cellular network 70 via WLAN 71. As such, path 74 will be associated to PDG for this embodiment. For example, MN 10 wants to use the WLAN interface 79b to gain access into the cellular network 70. Thus, WLAN interface 10b communicates with PDG via WAN 13 and presents the address configured in WLAN 71 (CoA.WLAN) along with the authentication data for MN 10. The PDG will contact an AAA server located in the cellular network 70 to authenticate if MN 10 is a valid subscriber of the cellular operator. Once authenticated, an address will be assigned to MN 10. The address may be configured in the cellular network 70 (HoA.WLAN) for WLAN interface 79b to use within cellular network 70. In one embodiment, HoA.WLAN can be assigned using stateless auto-configuration. This can be achieved by asking the PDG to advertise the cellular network prefix to MN 10. In another preferred embodiment, HoA.WLAN can be assigned using stateful configuration. This can be achieved by asking a Dynamic Host Configuration Protocol (DHCP) server to inform the PDG of the assigned address of MN 10. With knowledge of HoA.WLAN, the PDG will map HoA.WLAN to CoA.WLAN. This mapping would allow the PDG to perform address translation within the cellular network 70 for MN 10. Furthermore, PDG will bind HoA.WLAN at HA 11. This allows PDG to act as a proxy on behalf of MN 10. Any packet addressed to HoA.WLAN will be forwarded from HA 11 to the PDG who will in turn forward it to MN 10 via CoA.WLAN.

In a further preferred embodiment, MN 10 may wish to bind CoA.WLAN at HA 11 even if HoA.WLAN has been assigned to MN 10 via the PDG. For this embodiment, HA 11 can use the verification method of the present invention to verify the reachability for CoA.WLAN of MN 10.

With the detailed invention explained, a person skilled in the art should appreciate that the present invention differs from the method that is described in Non-patent document 4. In Non-patent Document 4, the correspondent (e.g home agent) would disable the binding cache entry (BCE) of the mobile node (MN) until the CoA has been verified. In the event that the home agent (HA) implements the BCE as an single entry for MN which includes a home address (HoA) bound to multiple CoAs, disabling the BCE would cause a problem when the HA wants to route packets to MN. This is due to the fact that CoAs that have been verified for their reachability would also be disabled. Thus, this implies that during the verification process done by the HA, MN would not be able to receive any packets even from CoAs that have already been verified. The present invention overcomes this problem by ensuring that the HA implements the BCE in a way that each entry of MN is treated as an individual entry. As such, the states for each entry would be independent of each other.

Additionally, a person skilled in the art would concur that the verification of the CoA in the present invention differs from the method described in Non-patent Document 5. In Non-patent Document 5, the method of verifying a CoA is for the correspondent node (CN) to send an Internet Control Messaging Protocol (ICMP) echo request to the CoA of the mobile node (MN). If CN receives a reply from MN via the CoA, CN would then verify that CoA for MN is reachable. This implies that for a given number of CoAs of MN to be verified, CN would have to send the same number of ICMP echo request message. For example, if MN has three unverified CoAs, CN would have to send and receive three ICMP echo request and response message in order to verify all the CoAs of MN. However, in the present invention, the verification method actually reduces the amount of message exchanges by asking MN to reply via another unverified CoA. For example, HA would send a message to MN via one of the unverified CoA and ask MN to reply back via another unverified CoA. This process, as compared to the use of ICMP messages, cuts the amount of message exchanges by half.

Furthermore, it will be obvious to a person skilled in the art that home cellular network 70 may be implemented using a Proxy Mobile IP (PMIP) protocol defined by the Network-based Local Mobility Management (NetLMM) working group in the Internet Engineering Task Force (IETF).

Although the invention has been herein shown and described in what is conceived to be the most practical and preferred embodiment, it will be appreciated by those skilled in the art that various modifications may be made in details of design and parameters without departing from the scope of the invention.

Each functional block used in the above-mentioned embodiments of the present invention is typically realized as an LSI (Large Scale Integrated Circuit) which is an Integrated Circuit. Functional blocks can be processed into 1-chip respectively, and part or all of functional blocks can be processed into 1-chip so as to be included in 1-chip. The above LSI can be called IC (Integrated Circuit), System LSI or Super LSI, according to the degree of integration.

Furthermore, the way to be processed into Integrated Circuit is not only to manufacture LSI but also to produce a dedicated circuit or a general processor. After manufacturing LSI, FPGA (Field Programmable Gate Array) to be programmable, or Reconfigurable Processor to be reconfigure connection or configuration of circuit cells in LSI can be utilized.

Furthermore, if another new technology of integration substituting for LSI appears due to development of the semiconductor technology or creation of another technology, functional blocks can be of course integrated by using the new technology. For example, the biological technology may be the new technology.

### INDUSTRIAL APPLICABILITY

The present invention can be applied in the technical field of telecommunications in mobile communications networks, especially can be applied to the technique relating to how to verify the care-of address.

1. A method of verifying a binding address, wherein a first node verifies multiple addresses corresponding to a second node, comprising:
a step in which the first node stores each binding entry for each of the multiple addresses;
a step in which the first node marks each binding entry as unverified; and
a verification step in which the first node verifies addressability for an address in a binding entry marked as unverified.

2. The method of verifying a binding address according to claim 1, wherein the verification step comprises:
a step in which the first node, upon receiving a binding message informing the multiple address from the second node, checks if the multiple addresses contain an address used as a source address of the binding message; and
a step in which the first node marks a binding entry including the address used as the source address of the binding message as verified.

3. The method of verifying a binding address according to claim 1, wherein the verification step comprises:
a step in which the first node sends a message to an address in a binding entry marked as unverified; and
a grasping step in which the first node grasps that the message has been received by the second node.

4. The method of verifying a binding address according to claim 3, wherein the grasping step comprises a step in which the first node receives a response message in respect to the message from the second node.

5. The method of verifying a binding address according to claim 1, wherein the verification step comprises:
a step in which the first node chooses two addresses from the multiple addresses in the binding entries as unverified;
a step in which the first node sends a message requesting a response message which is transmitted via a first chosen address to a second chosen address; and
a step in which the first node, upon receiving the response message transmitted via the first chosen address, marks a binding entry including the first chosen address and a binding entry including the second chosen address, as verified.

6. The method of verifying a binding address according to claim 1, wherein the verification step comprises:
a step in which the first node sets a short lifetime to the binding entries as unverified;
a step in which the first node sends a notifying message notifying that the lifetime of addresses in the binding entries marked as unverified is about to expire, to the second node;
a step in which the second node sends an update message for updating the binding entries for addresses marked as unverified, to the first node, as a response of the notifying message; and
a step in which the first node marks a binding entry including an address used for a destination address of the notifying message and a binding entry including an address used for a source address of the update message, as verified.

7. The method of verifying a binding address according to claim 1, wherein the verification step comprises:
a step in which the first node sets a short lifetime to the binding entries as unverified;
a step in which the first node chooses two addresses from the multiple addresses in the binding entries as unverified;
a step in which the first node sends a notifying message requesting a response message which is transmitted via a first chosen address and notifying that the lifetime of addresses in the binding entries marked as unverified is about to expire, to a second chosen address;
a step in which the first node, upon receiving the response message transmitted via the first chosen address, marks a binding entry including the first chosen address and a binding entry including the second chosen address, as verified; and
a step in which the first node, upon receiving an update message for updating the binding entries for addresses marked as unverified addresses as a response of the notifying message from the second node, marks a binding entry including an address used for a destination address of the notifying message and a binding entry including an address used for a source address of the update message, as verified.

8. An apparatus for verifying a binding address, the apparatus installed in a first node, wherein a first node verifies multiple addresses corresponding to a second node, comprising:
means for storing each binding entry for each of the multiple addresses;
means for marking each binding entry as unverified; and
verification means for verifying addressability for an address in a binding entry marked as unverified.

9. The apparatus for verifying a binding address according to claim 8, wherein the verification means comprises:
means for, upon receiving a binding message informing the multiple address from the second node, checking if the multiple addresses contain an address used as a source address of the binding message; and
means for marking a binding entry including the address used as the source address of the binding message as verified.

10. The apparatus for verifying a binding address according to claim 8, wherein the verification means comprises:
means for sending a message to an address in a binding entry marked as unverified; and
grasping means for grasping that the message has been received by the second node.

11. The apparatus for verifying a binding address according to claim 10, wherein the grasping means comprises means for receiving a response message in respect to the message from the second node.

12. The apparatus for verifying a binding address according to claim 8, wherein the verification means comprises:
means for choosing two addresses from the multiple addresses in the binding entries as unverified;
means for sending a message requesting a response message which is transmitted via a first chosen address to a second chosen address; and
means for receiving the response message transmitted via the first chosen address, marks a binding entry including the first chosen address and a binding entry including the second chosen address, as verified.

13. The apparatus for verifying a binding address according to claim 8, wherein the verification means comprises:
means for setting a short lifetime to the binding entries as unverified;
means for sending a notifying message notifying that the lifetime of addresses in the binding entries marked as unverified is about to expire, to the second node; and
means for marking, upon receiving an update message for updating the binding entries for addresses marked as unverified from the first node as a response of the notifying message, a binding entry including an address used for a destination address of the notifying message and a binding entry including an address used for a source address of the update message, as verified.

14. The apparatus for verifying a binding address according to claim 8, wherein the verification means comprises:
means for setting a short lifetime to the binding entries as unverified;
means for choosing two addresses from the multiple addresses in the binding entries as unverified;
means for sending a notifying message requesting a response message which is transmitted via a first chosen address and notifying that the lifetime of addresses in the binding entries marked as unverified is about to expire, to a second chosen address;
means for, upon receiving the response message transmitted via the first chosen address, marking a binding entry including the first chosen address and a binding entry including the second chosen address, as verified; and
means for, upon receiving an update message for updating the binding entries for addresses marked as unverified addresses as a response of the notifying message from the second node, marks a binding entry including an address used for a destination address of the notifying message and a binding entry including an address used for a source address of the update message, as verified.

15. A mobile node comprising;
means for managing multiple addresses corresponding to the mobile node itself;
means for registering and updating the multiple addresses of the mobile node at an address management apparatus;
means for receiving a message from a first address, the message requesting a response message which is transmitted via a second address; and
means for sending the response message via the second address.

16. The method of verifying a binding address according to claim 1, wherein the verification step comprises:
a step in which the first node indicates the second node's binding entries to the second node in a reply message, wherein said binding entries for addresses are marked as unverified or verified;
a step in which the first node receives a data packet from the second node from a said unverified address; and
a step in which the first node, upon receiving the data packet, marks said unverified address binding entry to verified.

17. The apparatus for verifying a binding address according to claim 8, wherein the verification means comprises:
means for sending a message to indicate the status of binding entries; and
means for, upon receiving an message for addresses marked as unverified from the second node, marks said binding entry as verified.
